(19) United States
(12) Patent Application Publication
(10) Pub. No.: US 2026/0198516 A1
(43) Pub. Date: Jul. 16, 2026

(54) Vertical Slush Machine

(71) Applicant: Cixi City Spring Electric Appliance Co., Ltd., Cixi (CN)

(72) Inventor: Hongya YU, Cixi (CN)

(73) Assignee: Cixi City Spring Electric Appliance Co., Ltd., Cixi (CN)

(21) Appl. No.: 19/564,123

(22) Filed: Mar. 11, 2026

(30) Foreign Application Priority Data
Jan. 28, 2026 (CN) 202620117349.1

(51) Int. Cl. A23G 9/04

(52) U.S. Cl. CPC A23G 9/045

(57) ABSTRACT

Disclosed is a vertical slush machine, including a main unit with a discharge seat for dispensing smoothie beverages; a processing component vertically positioned above and connected to the discharge seat; a processing chamber communicating with the discharge port of the discharge seat; and a refrigeration device located inside the main unit for cooling the processing component. The processing component includes an ice-making cylinder, a scraper fitted around the outside of the ice-making cylinder, and a material cylinder. The material cylinder is hollow and extends to a lower opening, with the lower end abutting against the upper surface of the discharge seat, thus establishing communication between the processing chamber and the discharge port. The top of the material cylinder has a liquid injection port, and the top of the material cylinder is openable and covered by a material cylinder cover to conceal the liquid injection port.

### TECHNICAL FIELD

The present disclosure relates to the field of ice making equipment, and more particularly to a vertical slush machine.

### BACKGROUND

A slush machine is a type of cold beverage preparation equipment, also known as an ice maker, smoothie maker, or shaved ice machine. Traditionally, cold beverages were made by adding ice cubes, but melting ice diluted the beverage, making it bland and tasteless, severely impacting its flavor. Therefore, slush machines were developed to simultaneously maintain the beverage's low temperature, concentration, and smooth texture.

Slush machines can generally be categorized into horizontal and vertical types. In a horizontal slush machine, the mixing blades are installed horizontally and spirally propelled. The slush machine continuously pushes the smoothie to the front of the blades. Smoothies at the very front, being further away from the blades, are not continuously mixed and tend to remelt, affecting the final product. Vertical slush machines, on the other hand, effectively address this issue. Because the smoothies are held at the bottom of the container by gravity, the finished smoothie is constantly agitated by the blades, maintaining a smooth and fine texture.

Chinese patent application CN121101056A discloses a compact vertical slush machine, comprising a material container, stirring blades, a shell, a refrigeration assembly, a condenser bracket, an inner mounting base, and a drive motor. The shell comprises a front body and a rear body, with the material container located on top of the front body. The refrigeration assembly comprises a compressor, a condenser, an expansion valve, and an evaporator. The condenser bracket is fixed within the cavity of the rear body, and the condenser, electrical control module, and compressor form a three-layer structure arranged vertically. The inner mounting base is fixed within the cavity of the front body and isolated from the inner cavity of the material container. The drive motor is fixed within the inner mounting base. The present disclosure achieves a compact structural layout, realizing miniaturization and high integration, making it suitable not only for commercial kitchen environments but also for home kitchen environments with high space requirements, thus improving the applicability and versatility of the slush machine.

However, in the refrigeration units of existing slush machines, only a compressor and a condenser are typically installed. The refrigerant circulates among the compressor, condenser, and evaporator. During this circulation, debris or oxide scale and other impurities accumulate on the inner walls of the metal components. These impurities enter the compressor cylinder along with the refrigerant, causing severe wear on the piston, cylinder wall, or valve plates. This leads to decreased compressor airtightness, insufficient discharge pressure, and ultimately fatal malfunctions such as cylinder scoring or bearing seizure. Further, impurities may accumulate directly on the expansion valve core or the inlet of the capillary tube, forming a “clogging” effect. This prevents the refrigerant from properly throttling and depressurizing, resulting in insufficient liquid supply to the evaporator, a sharp drop in cooling capacity, or even a complete loss of cooling ability.

### SUMMARY

To address the aforementioned problems in the existing technology, the present disclosure provides a vertical slush machine/smoothie maker.

The aforementioned problems of the present disclosure are solved by the following technical solutions:

A vertical slush machine, comprising:
a main unit equipped with a discharge seat for dispensing smoothie beverages;
a processing component, vertically positioned above the discharge seat and forms a connection with the discharge seat;
a processing chamber, connected to a discharge port of the discharge seat;
a refrigeration device, located inside the main unit, used to cool the processing component;
wherein the processing component comprises an ice-making cylinder, a scraper sleeved on the outside of the ice-making cylinder, and a material cylinder, wherein the material cylinder and the ice-making cylinder constitute the processing chamber;
the material cylinder is hollow inside and extends to a lower opening, and a lower end of the material cylinder abuts against an upper surface of the discharge seat so that the processing chamber and the discharge port are connected;
the top of the material cylinder is provided with a liquid injection part, and the top of the material cylinder is openable and a material cylinder cover is provided to cover the liquid injection part;
the material cylinder cover is provided with a balancing air passage;
the material cylinder cover has a groove, a groove wall of the groove extends toward the liquid injection part and has an air groove, the groove and the air groove are connected to form a balancing air passage connecting the liquid injection part and the outside.

According to some embodiments of the present disclosure, the top of the material cylinder is provided with a plurality of liquid injection holes, and the liquid injection holes penetrate through the top of the material cylinder;
the top of the material cylinder is recessed to form a liquid guiding groove, and the liquid injection holes are formed at the bottom of the liquid guiding groove;
the liquid guiding groove and the liquid injection holes together constitute the liquid injection part.

According to some embodiments of the present disclosure, the liquid guiding groove comprises a liquid inlet area located in the center and a liquid guiding area surrounding the liquid inlet area, wherein an inner connecting end of the liquid guiding area is lower than an outer connecting end of the liquid guiding area.

According to some embodiments of the present disclosure, a central liquid hole is provided at the center of the liquid injection part, and arc-shaped baffles are formed around the central liquid hole on the inner wall of the material cylinder, and multiple arc-shaped baffles constitute a baffle ring with a liquid passage gap;
the gap of the baffle ring is located above a rotating shaft of the ice-making cylinder.

According to some embodiments of the present disclosure, the refrigeration device comprises a compressor and a condenser connected in series, the compressor is fixed inside the main unit, a cooling fan is provided on a first side of the condenser, a filter is provided on a second side of the condenser, and the filter is connected to a medium outlet of the condenser and an input port of the processing component to deliver a cooling medium to the refrigeration device.

According to some embodiments of the present disclosure, the main unit is provided with an air outlet, and the filter, the condenser and the cooling fan are arranged in sequence along the direction of airflow output.

According to some embodiments of the present disclosure, the filter is configured as a strip-shaped tube structure extending along an axis L, and a filter inlet and a filter outlet are arranged at two ends along the axis L;
the axis L is set perpendicular to an output direction of heat dissipation airflow.

According to some embodiments of the present disclosure, a circuit board box is further provided inside the main unit for accommodating a circuit board; the circuit board box is located on one side of the filter and forms a first heat dissipation plane perpendicular to the output direction of the heat dissipation airflow together with the filter.

According to some embodiments of the present disclosure, a temperature sensor is provided on the discharge seat, and a temperature probe of the temperature sensor extends into the processing chamber;
the temperature sensor is covered with an insulating sleeve;
the insulation sleeve is wrapped around an outer periphery of the temperature sensor extending to a lower part of the discharge seat.

According to some embodiments of the present disclosure, a handle is formed on the main unit, the handle is symmetrically arranged on both sides of the bottom of the main unit, and is provided with a force-bearing end face for fingertips of a person to abut;
the force-bearing end face is an upper end face of the handle.

Compared with the prior art, the beneficial effects of the present disclosure are as follows:

A balancing air passage is set on the material cylinder cover. When the output of slush/smoothie from the material outlet causes the material in the processing chamber to decrease and generate negative pressure, external air can enter the processing chamber through the balancing air passage and the liquid injection part, so that the internal air pressure is balanced with the external air pressure, ensuring that the slush can be smoothly output from the material outlet under the action of gravity, effectively solving the problem of poor material discharge caused by negative pressure in the existing vertical slush machine.

Adding a filter between the condenser and the processing component can effectively filter out impurities such as metal scraps and oxide scale generated during the circulation of the refrigerant, preventing impurities from entering the compressor and causing fatal failures such as “cylinder scoring” or “shaft seizure”, or clogging the expansion valve and capillary tube, resulting in loss of cooling capacity, thus greatly improving the reliability and service life of the equipment.

By wrapping the temperature sensor with an insulation sleeve made of rubber and plastic insulation cotton, the sensor is isolated from the internal space of the main unit. When the internal temperature of the main unit is higher or lower than the sensor temperature, the insulation sleeve can achieve heat insulation or heat preservation respectively, ensuring that the sensor detects the true real-time temperature of the ice slush inside the chamber, avoiding the influence of heat from components such as the compressor inside the main unit on the accuracy of temperature measurement, thereby accurately controlling the refrigeration device and outputting ice slush that meets the user's set temperature;

The main unit has symmetrical handles on both sides of the bottom, which are hidden in the bottom through a groove design. This not only does not affect the uniformity of the slush machine's appearance, but also allows users to easily apply force when moving it, solving the problem of the curved shell being difficult to grip.

### BRIEF DESCRIPTION OF THE DRAWINGS

FIG. 1 is a schematic view of the overall structure of the present disclosure.

FIG. 2 is a cross-sectional structural diagram of the present disclosure.

FIG. 3 is a schematic view of the exploded structure of the processing component.

FIG. 4 is an isometric sectional view of the processing component.

FIG. 5 is a schematic view of the structure at the top of the material cylinder.

FIG. 6 is an enlarged structural diagram of part A in FIG. 2.

FIG. 7 is a schematic view of the movement path of the heat dissipation airflow.

FIG. 8 is a schematic view of the side structure of the condenser.

FIG. 9 is a schematic view of the main structure of the condenser.

FIG. 10 is a cross-sectional view of the temperature sensor.

FIG. 11 is an isometric sectional view of the installation location on the discharge seat.

FIG. 12 is an enlarged structural diagram of part B in FIG. 10.

FIG. 13 is an exploded structural diagram of the bottom shell body and side enclosure in Embodiment 1.

FIG. 14 is a schematic view of the connection structure between the bottom shell body and the side enclosure in Embodiment 1.

FIG. 15 is a schematic view of the bottom shell structure.

Reference numerals: 100, Main unit; 110, Discharge seat; 112, Sleeve; 113, Discharge top; 114, Support shell; 115, Isolation layer; 115.1, Limiting rib; 116, Stabilizing ring; 120, Air outlet grille; 130, Bottom shell body; 140, Side enclosure; 131, Handle; 131.1, Force-bearing end face; 132, Bottom enclosure; 133, Air inlet area; 133.1, Air inlet slot; 133.2, Air guide strip; 134, Mounting column;

200, Processing component; 210, Ice making cylinder; 211, Rotating shaft; 220, Scraper; 230, Material cylinder; 231, Liquid guide groove; 232, Baffle; 233, Stepped surface; 231.1, Liquid injection hole; 231.2, Liquid inlet area; 231.3, Liquid guide area(guiding area); 231.4, Central liquid hole; 240, Material cylinder cover; 241, Balancing air passage; 241.1, Groove; 241.2, Air groove; 242, Handle;

300, Refrigeration device; 310, Compressor; 320, Condenser; 330, Cooling fan; 340, Filter;

a, Processing chamber; b, Discharge port; c, Liquid passage gap; 1, Valve body; 2, Circuit board box; 3, Temperature sensor; 3.1 Temperature probe; 3.2 Wiring part; 4, Insulation sleeve; 4.1, Through hole.

### DETAILED DESCRIPTION OF EMBODIMENTS

To further illustrate the technical means and effects of the present disclosure in achieving its intended purpose, the following detailed description of the specific implementation methods, structures, features, and effects of the present disclosure, in conjunction with the accompanying drawings and preferred embodiments, are provided below.

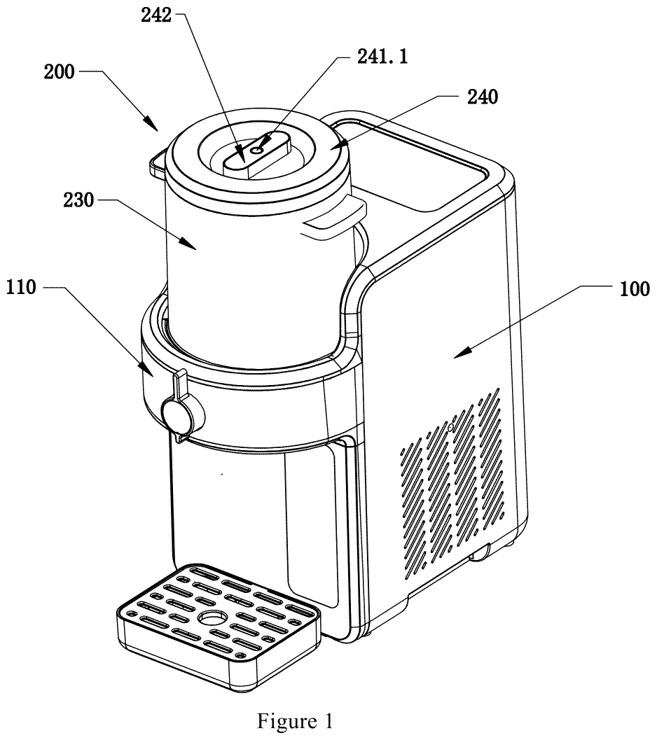

As shown in FIG. 1, this embodiment discloses a vertical slush machine.

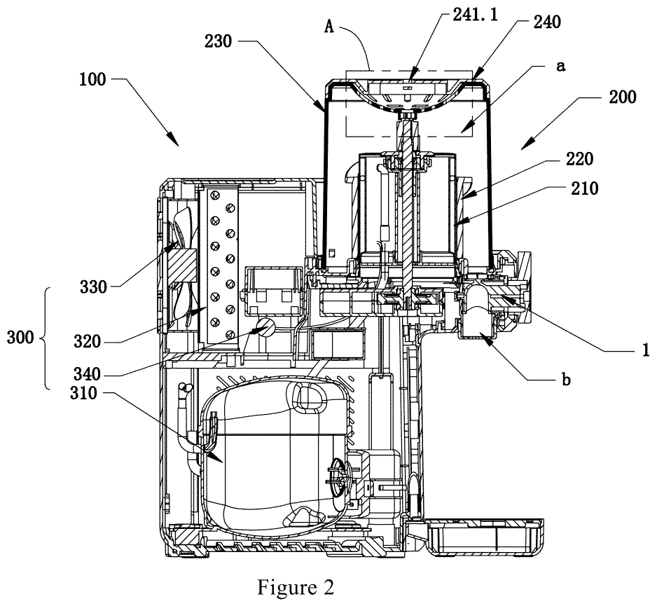

See FIGS. 1 and 2 for details, it includes:
a main unit 100, equipped with a discharge seat 110 for dispensing smoothie beverages;
a processing component 200, vertically arranged above the discharge seat 110 and forms a processing chamber a between it and the discharge seat 110. The processing chamber a is connected to the discharge port b of the discharge seat 110;
a refrigeration device 300, located inside the main unit 100 and used to cool the processing component 200;

The processing component 200 includes an ice-making cylinder 210, a scraper 220 sleeved on the outside of the ice-making cylinder 210, and a material cylinder 230, wherein the material cylinder 230 and the ice-making cylinder 210 constitute the processing chamber a.

The material cylinder 230 is hollow inside and extends to the lower opening, with the lower end abutting against the upper surface of the discharge seat 110, so that the processing chamber a and the discharge port b are connected.

The top of the material cylinder 230 is provided with a liquid injection part, and the top of the material cylinder 230 can be opened and a material cylinder cover 240 is provided to cover the liquid injection part.

The material cylinder cover 240 is provided with a balancing air passage 241;

The material cylinder cover 240 has a groove 241.1 formed on it. The groove wall of the groove 241.1 extends toward the liquid injection part and has an air groove 241.2. The groove 241.1 and the air groove 241.2 are connected to form a balancing air passage 241 that connects the liquid injection part and the outside.

The above is the basic scheme of this embodiment.

The processing component 200 includes an ice-making cylinder and a scraper located outside the ice-making cylinder. The structure of the ice-making cylinder and the scraper is consistent with that of the existing slush machine, and will not be described in detail here.

When using the slush machine, open the material cylinder cover 240 above the material cylinder 230 and inject the beverage concentrate into the processing chamber a through the injection port at the top of the material cylinder 230. After adding, close the material cylinder cover 240, turn on the main unit 100, and the refrigeration device 300 inside the main unit 100 will start, supplying cooling to the ice-making cylinder 210, instantly cooling the outer surface of the ice-making cylinder 210. The beverage concentrate in contact with the outer surface of the ice-making cylinder 210 cools down and condenses, forming an ice layer. As the ice-making cylinder 210 rotates, the scraper 220 scrapes off the ice layer and mixes it into the beverage concentrate to form slush. New liquid beverage concentrate forms an ice layer on the outer surface of the ice-making cylinder 210, which is then scraped off and mixed into the beverage concentrate again. After repeated cycles, more and more ice is mixed in the beverage concentrate, thus forming a slush that is simultaneously mixed with ice particles and liquid. When the user wants to use it, simply open the discharge port b of the discharge seat 110.

In this embodiment, a valve body 1 is provided at the discharge port b to control the opening and closing of the discharge port b.

When slush is discharged from the discharge port b, if the material in the processing chamber a decreases without replenishment, a negative pressure will be generated in the processing chamber a. The pressure outside the discharge port b will be greater than the pressure inside the processing chamber a, and the slush cannot be discharged smoothly from the discharge port b. Therefore, in this embodiment, a balancing air passage 241 is provided on the material cylinder cover 240. External air enters the processing chamber a through the balancing air passage 241 and the liquid injection part in sequence to replenish it, so that the air pressure inside the processing chamber a is always balanced with the external air pressure, thereby enabling the slush to be discharged smoothly from the discharge port b under the action of gravity.

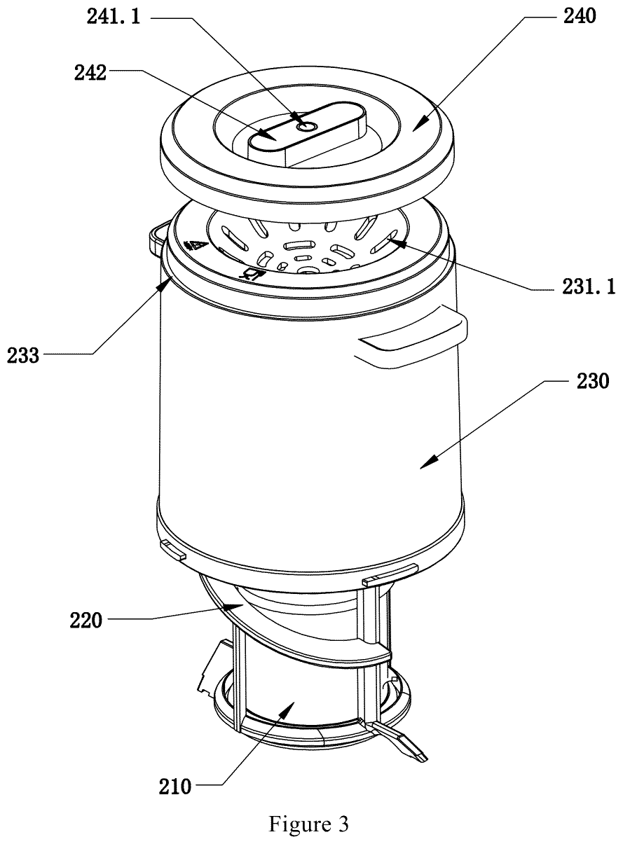

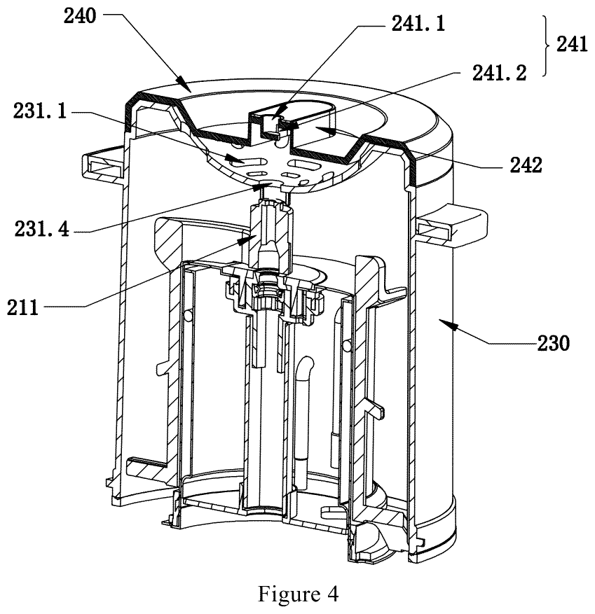

Referring specifically to FIGS. 3 and 4, in this embodiment, the air passage is configured as an L-shaped structure. The external gas first moves along the axial direction of the groove 241.1, and then enters the liquid injection part from the air groove 241.2 on the side of the groove 241.1, forming an L-shaped movement path. Compared with a straight air passage, the L-shaped air passage converts the axial airflow into radial diffusion, making the airflow more stable and ensuring the stability of ventilation.

Preferably, in this embodiment, the top of the material cylinder 230 is provided with a plurality of injection holes 231.1, and the injection holes 231.1 extend through the top of the material cylinder 230;

The top of the material cylinder 230 is recessed to form a liquid guiding groove 231, and the liquid injection holes 231.1 are formed at the bottom of the liquid guiding groove 231.

The liquid guiding groove 231 and the liquid injection holes 231.1 together constitute the liquid injection part.

To effectively prevent impurities such as large pieces of fruit or ice from entering the beverage processing chamber a during the beverage production process, which could prevent the formation of a uniform and smooth slush and affect the quality and taste of the final product, this embodiment employs filtration of the injected beverage concentrate. By providing an injection hole 231.1 at the injection site, only liquid and very small ice particles or fruit pieces can pass smoothly through the injection hole 231.1 into the processing chamber a during beverage concentrate injection. This ensures that the final slush is free of large pieces of fruit or ice, resulting in a more uniform texture and taste.

In this embodiment, the top of the material cylinder 230 is designed as a groove structure. The center of this groove structure is lower than the edge. In this way, when the beverage concentrate is poured in, the groove structure can effectively receive the poured liquid. Moreover, due to this special design of the groove structure, the liquid at the edge will naturally converge towards the center before being injected.

Based on the above settings, it is possible to effectively prevent the beverage concentrate from splashing out and falling outside the material cylinder 230 during the dispensing process. If the beverage concentrate splashes outside the material cylinder 230, it is very likely to stain the surrounding area such as the table, and this design effectively avoids such problems.

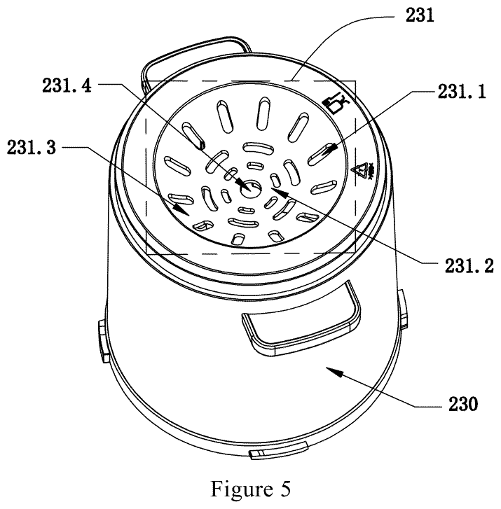

Referring specifically to FIG. 5, in this embodiment, the liquid guiding groove 231 includes a liquid inlet area 231.2 located at the center and a liquid guiding area 231.3 surrounding the liquid inlet area 231.2. The inner connecting end of the liquid guiding area 231.3 is lower than the outer connecting end.

In this embodiment, the liquid guiding groove 231 is arranged concentrically as an inlet area 231.2 and a guiding area 231.3, with the inlet area 231.2 being a horizontal surface and the guiding area 231.3 having an inclined surface. When the user pours the beverage concentrate into the liquid guiding groove 231, some of the beverage concentrate is poured into the guiding area 231.3 and flows along the inclined surface of the guiding area 231.3 to the inlet area 231.2, and then enters the processing chamber a through the injection hole 231.1 from the inlet area 231.2.

Based on the above configuration, splashing of the beverage concentrate can be avoided. Simultaneously, the beverage concentrate is collected and injected into the center of the liquid guide groove 231, allowing it to enter from the center of the processing chamber a. Inside processing chamber a, the ice-making cylinder 210 is located in the center of processing chamber a. This means that the beverage concentrate entering processing chamber a preferentially contacts the ice-making cylinder 210 and then flows along its surface, ensuring that the surface of the ice-making cylinder 210 is coated with beverage concentrate, thus enabling the creation of an ice layer from the beverage concentrate.

Preferably, in this embodiment, the projection of the liquid inlet area 231.2 is located on the axial end face of the ice-making cylinder 210.

Furthermore, in this embodiment, the projected area of the liquid inlet area 231.2 on the ice-making cylinder 210 is smaller than the radial area of the ice-making cylinder 210. This means that the beverage concentrate injected from the liquid inlet area 231.2 can completely fall onto the upper surface of the ice-making cylinder 210. After the beverage concentrate falls onto the upper surface of the ice-making cylinder 210, it will slowly slide down the outer circumference of the ice-making cylinder 210. At the same time, a portion of the beverage concentrate injected from the liquid guiding area 231.3 will also fall onto the upper surface of the ice-making cylinder 210. This beverage concentrate injected from the liquid guiding area 231.3 and falling onto the upper surface will then slowly slide down the outer circumference of the ice-making cylinder 210. The purpose of this is to ensure that the outer circumference of the ice-making cylinder 210 can contact the beverage concentrate as much as possible. By increasing the contact area between the outer circumference of the ice-making cylinder 210 and the beverage concentrate, the ice-making efficiency can be effectively improved.

Furthermore, in this embodiment, the projection of the injection hole 231.1 on the ice-making cylinder 210 is located on the upper end surface of the ice-making cylinder 210. That is to say, the beverage concentrate that enters the processing chamber a through the injection hole 231.1 can contact the upper end surface of the ice-making cylinder 210 and then flow along the outer circumferential surface of the ice-making cylinder 210.

Preferably, in this embodiment, the inner connecting end and the outer connecting end of the liquid guiding area 231.3 form an arc-shaped transition.

Compared to using a sloping plane for the transition, this embodiment uses a curved surface. This curved surface transition effectively slows down the flow of the beverage concentrate along the curved surface. Because of its unique shape, the curved surface doesn't allow the beverage concentrate to slide down relatively quickly like a sloping plane; instead, it obstructs the flow of the beverage concentrate to a certain extent, slowing down its flow speed. If the beverage concentrate flows at high speed to the outside of the injection hole 231.1, the impact force and excessive flow rate may cause the concentrate to accumulate around the injection hole 231.1, leading to blockage and affecting subsequent injection operations. The curved surface transition method in this embodiment effectively avoids this problem.

In addition, in this embodiment, a central liquid hole 231.4 is provided at the center of the liquid injection part, and an arc-shaped baffle 232 is formed around the central liquid hole 231.4 on the inner wall of the material cylinder 230. Multiple arc-shaped baffles 232 constitute a baffle ring with a liquid passage gap c.

The gap of the baffle ring is located above the rotating shaft 211 of the ice-making cylinder 210.

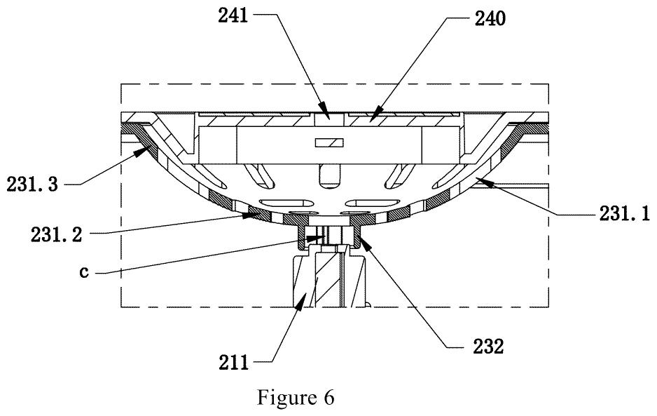

Referring specifically to FIG. 6, in this embodiment, to ensure a balanced air intake, a central liquid hole 231.4 is specifically provided at the center of the liquid injection area. This central liquid hole 231.4 can be used for liquid injection, allowing liquid to smoothly enter the processing chamber a; simultaneously, it can also be used for air intake. Furthermore, the liquid injection holes 231.1 are arranged concentrically around the central liquid hole 231.4. This carefully designed arrangement effectively ensures the balance of liquid intake, allowing the liquid to be evenly and stably distributed during the injection process.

Furthermore, multiple arc-shaped baffles 232 are provided on the upper end face of the material cylinder 230 facing the processing chamber a. A liquid passage gap c is formed between two adjacent baffles 232. The multiple baffles 232 form a baffle ring. The internal space of the baffle ring is connected to the central liquid hole 231.4. The beverage raw liquid or gas input from the central liquid hole 231.4 is output laterally to the processing chamber a through the liquid passage gap c.

In this embodiment, to ensure the installation of the material cylinder cover 240 on the material cylinder 230, a stepped surface 233 is formed on the outer periphery of the material cylinder 230. The stepped surface 233 makes the outer diameter of the upper part of the material cylinder 230 smaller than the outer diameter of the lower part. The material cylinder cover 240 covers the upper part of the material cylinder 230 and abuts against the stepped surface 233.

Referring specifically to FIGS. 2 and 3, in this embodiment, the upper and lower parts of the material cylinder 230 are configured as two structures with different outer diameters, and the outer diameter of the upper part is smaller than that of the lower part, so that a stepped surface 233 is formed at the junction of the two parts. The material cylinder cover 240 is a shell structure with an open bottom, and the inner diameter of the hollow part is the same as the outer diameter of the upper part of the material cylinder 230, and the thickness of the side wall is the same as the width of the stepped surface 233. Thus, when the material cylinder cover 240 covers the upper part of the material cylinder 230, the lower end of the side wall is exactly aligned with the stepped surface 233, forming a complete integrated structure with the lower part of the material cylinder 230.

Preferably, in order to facilitate lifting the material cylinder cover 240, the material cylinder cover 240 in this embodiment is provided with a handle 242, and the balancing air passage 241 is formed on the handle 242.

The handle 242 is located at the center of the top of the material cylinder cover 240 and is a protruding structure, making it convenient for the user to lift.

The refrigeration device 300 includes a compressor 310 and a condenser 320 connected together. The compressor 310 is fixed inside the main unit 100. A cooling fan 330 is provided on the first side of the condenser 320, and a filter 340 is provided on the second side of the condenser 320. The filter 340 is connected to the medium outlet of the condenser 320 and the input port of the processing component 200 to deliver a refrigerant medium to the refrigeration component.

Inside the main unit 100, the compressor, through the movement of a piston or scroll plate, compresses the gaseous refrigerant into high-temperature, high-pressure superheated vapor, causing the temperature and pressure of the refrigerant to rise instantaneously. The superheated vapor, driven by the pump, is fed through pipes to the condenser 320, where it rapidly cools and undergoes a phase change, transforming the refrigerant from a gaseous state to a liquid state. During this process, the refrigerant continuously releases heat, which is then channeled out of the main unit 100 by the cooling fan 330, forming a heat dissipation airflow. The subcooled liquid formed during this continuous heat release is then fed into the ice making cylinder to cool it. Finally, the refrigerant inside the ice making cylinder, along with the heat-absorbing refrigerant, is returned to the compressor 310 to continue the refrigeration cycle.

In this embodiment, a filter 340 is installed between the condenser 320 and the ice making cylinder to filter the subcooled liquid, remove impurities mixed in the subcooled liquid, and prevent impurities from entering the capillary tube of the ice making cylinder along with the subcooled liquid and causing blockage of the capillary tube.

Furthermore, in this embodiment, the filter 340 is positioned rearward, that is, on the other side of the condenser 320. When the cooling fan 330 on the first side of the condenser 320 drives the airflow, a heat dissipation airflow is formed that can pass through the condenser 320 and the cooling fan 330 in sequence. Since the filter 340 is positioned on the opposite side from the cooling fan 330, that is, the filter 340 is located on the movement path of the heat dissipation airflow, the refrigerant passing through the filter 340 can be cooled and cooled again simultaneously, thereby improving the cooling efficiency.

Specifically, in this embodiment, the main unit 100 is provided with an air outlet, and the filter 340, the condenser 320 and the cooling fan 330 are arranged sequentially along the direction of airflow output.

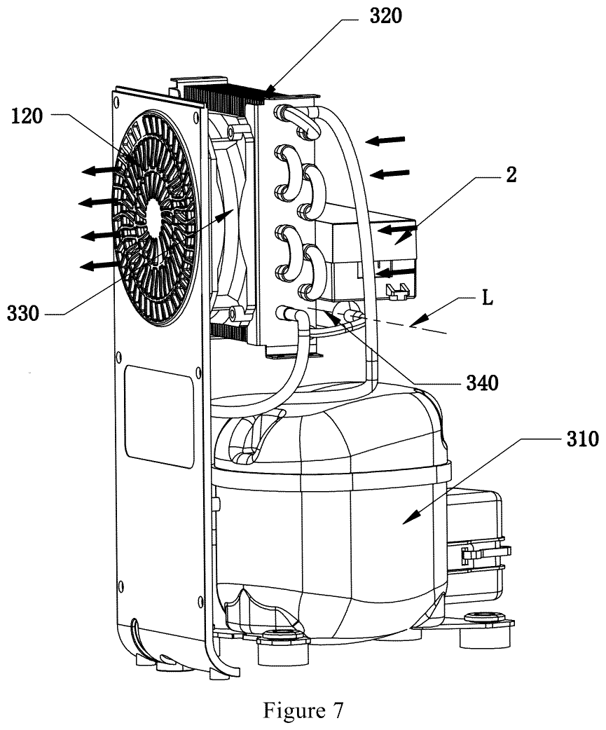

Referring specifically to FIG. 7, in this embodiment, an air outlet is provided on the housing of the main unit 100, and the air outlet is divided by baffles to form an air outlet grille 120; the cooling fan 330 is located inside the air outlet, and the airflow driving area of the cooling fan 330 is not less than the air outlet coverage area. The condenser 320 is disposed inside the cooling fan 330, and the filter 340 is disposed inside the condenser 320.

Based on the above configuration, when the cooling fan 330 is activated, a negative pressure is created in the area of the cooling fan 330, causing the air inside the cooling fan 330 to flow towards the cooling fan 330, forming a heat dissipation airflow. As the airflow inside the filter 340 moves outward, it carries away the heat from the filter 340, cooling it down. When this heat dissipation airflow reaches the condenser 320, it cools the condenser 320, carrying away the heat from it. Finally, the high-temperature heat dissipation airflow passes through the cooling fan 330 and is output to the outside of the main unit 100 from the air outlet.

In order to replenish the air inside the main unit 100, air inlets are provided at the bottom and sides of the main unit 100 in this embodiment.

Preferably, in this embodiment, the filter 340 is configured as a strip-shaped tubular structure extending along the axis L, and the filter inlet and filter outlet are arranged at two ends along the axis L.

The axis L is set perpendicular to the output direction of the heat dissipation airflow.

As the refrigerant moves from the filter inlet to the filter outlet within the filter 340, the cooling fan 330 passes through the filter 340 to synchronously cool the refrigerant flowing within the filter 340, ensuring that the cooling efficiency of the refrigerant within the filter 340 is consistent.

Compared to cooling each part of the filter 340 sequentially, the setup in this embodiment is better able to control the temperature of the cooling medium input into the ice making cylinder, thereby controlling the temperature of the resulting smoothie beverage.

In addition, in this embodiment, the main unit 100 is also provided with a circuit board box 2 for accommodating the circuit board; the circuit board box 2 is located on one side of the filter 340, and together with the filter 340, they form a first heat dissipation plane perpendicular to the heat dissipation airflow output direction.

The filter 340 is usually configured as a tubular component with a small cross-sectional area. In order to make the most of the heat dissipation space, in this embodiment, a circuit board box 2 is provided above the filter 340. When the heat dissipation airflow dissipates heat from the filter 340, it also dissipates heat from the circuit board box 2 above, thereby dissipating heat from the circuit board inside the circuit board box 2.

Furthermore, the heat dissipation airflow passing through filter 340 and circuit board box 2 is the initial airflow, that is, the heat dissipation airflow has not absorbed the heat of condenser 320, and the airflow temperature is relatively low, which can absorb the heat of circuit board box 2 as much as possible and ensure the temperature stability of the circuit board.

Preferably, in this embodiment, both the circuit board box 2 and the filter 340 are located within the airflow drive range of the cooling fan 330.

Based on the above configuration, the heat dissipation airflow is ensured to pass through the circuit board box 2 and the filter 340 during movement, thereby cooling both of them.

In this embodiment, the condenser 320 is specifically implemented as follows: the condenser 320 includes a plurality of fins 321 arranged parallel to the heat dissipation airflow output direction, and a heat exchange tube group that is S-shaped and coiled in the fins 321.

The heat exchange tube group includes a first tube group 322 and a second tube group 323 arranged in parallel, and the heat dissipation airflow passes through the first tube group 322 and the second tube group 323 in sequence.

The medium outlet d is located in the first tube group 322, and the medium inlet e is located in the second tube group 323.

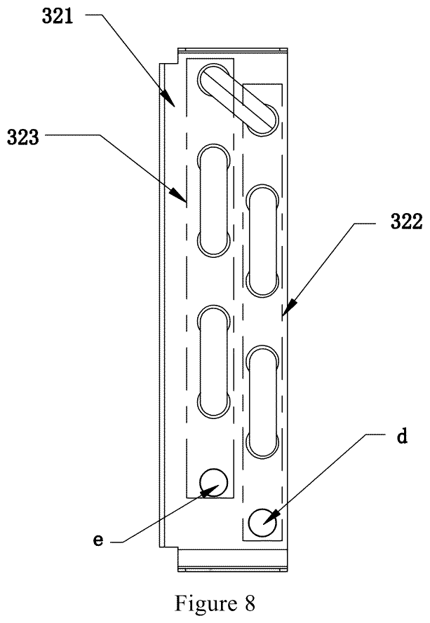

Referring to FIG. 8, the fin 321 is a strip-shaped rectangular sheet. The heat exchange tube assembly is arranged through the fin 321 along the thickness direction of the rectangular sheet, and multiple tubes are arranged sequentially along the length direction of the rectangular sheet, so that the heat exchange tube assembly forms multiple S-shaped structures connected end to end and coiled in the fin 321.

The output direction of the heat dissipation airflow is along the width direction of the fins 321, that is, it can drive the air in the gap between adjacent fins 321, thereby cooling the fins 321 and the heat exchange tube assembly.

The heat exchange tube assembly has two rows arranged on the fins 321, each row consisting of multiple heat exchanger tubes. The two rows of heat exchanger tube assemblies are arranged along the output direction of the heat dissipation airflow. The fins 321 have a first cooling side and a second cooling side along their width direction. The first cooling side is away from the cooling fan 330, and the second cooling side is relatively close to the cooling fan 330. The two rows of tubes of the heat exchange tube assembly are respectively arranged on the first cooling side and the second cooling side, forming a first tube assembly 322 on the first cooling side and a second tube assembly 323 on the second cooling side.

Based on the above settings, when the refrigeration device 300 is working, the cooling fan 330 starts to drive the air inside the main unit 100, and the driving direction is from the first cooling side to the second cooling side, that is, the first tube group 322 on the first cooling side is cooled first, and then the air passes through the second tube group 323 on the second cooling side.

The cooling principle is as follows: The refrigerant is input through the medium inlet e located in the second tube group 323. When the refrigerant flows through the tubes to the first tube group 322, it has already absorbed some heat through the tube wall of the first tube group 322. That is to say, the temperature of the refrigerant reaching the first tube group 322 is lower than the input temperature. When the airflow passes through the first cooling side, it absorbs the temperature of the first tube group 322, rapidly cooling the refrigerant within the first tube group 322, thus performing the first cooling of the refrigerant. When the heat dissipation airflow passes through the first cooling side, it dissipates heat and cools the first tube group 322, causing the refrigerant flowing within the first tube group 322 to undergo a second cooling.

At the same time, when the refrigerant is cooled for the first time in the second tube group 323, the heat dissipation airflow that absorbs the heat of the second tube group 323 also cools the second tube group 323, so that the temperature of the refrigerant when it enters the first tube group 322 is already low.

When the heat dissipation airflow passes through the first tube group 322, it is close to the initial temperature state and has a great heat absorption capacity. Therefore, it absorbs a large amount of heat from the first tube group 322, so that the refrigerant in the first tube group 322 is rapidly cooled down and then output from the medium outlet d.

Compared to the cooling principle in the prior art, this embodiment reverses the output direction of the heat dissipation airflow, so that the airflow first cools the low-temperature zone, so that the cooling medium output from the medium outlet d is output in the form of air temperature, and then cools the high-temperature zone, so that the cooling medium in the high-temperature zone enters the low-temperature zone in the form of temperature lower than the input temperature.

Specifically, the first tube group 322 includes a plurality of first straight tubes 322.1, the second tube group 323 includes a plurality of second straight tubes 323.1, the plurality of first straight tubes 322.1 are arranged sequentially along the length direction of the fins 321 to form a second heat dissipation plane, and the plurality of second straight tubes 323.1 are arranged sequentially along the length direction of the fins 321 to form a third heat dissipation plane.

The first heat dissipation plane, the second heat dissipation plane, and the third heat dissipation plane are parallel to each other.

During the flow, the airflow passes through the first heat dissipation plane, the second heat dissipation plane, and the third heat dissipation plane in sequence.

The refrigerant is input from the medium inlet e and flows along the second straight tube 323.1 within the third heat exchange plane. During the flow, some of the heat of the refrigerant is absorbed by the second straight tube 323.1, and the heat of the second straight tube 323.1 is carried away by the heat dissipation airflow. When the medium flows to the first straight tube 322.1, it has formed a medium with a medium temperature. The medium-temperature refrigerant flows along the first straight tube 322.1, and during the flow, its heat is absorbed by the heat dissipation airflow, quickly forming a low-temperature refrigerant, which is output from the medium outlet d.

Based on the above configuration, the multiple first straight tubes 322.1 in the first tube group 322 are placed on the same plane, so that when the heat dissipation airflow passes through the plane, it can simultaneously cool all tube parts in the first tube group 322 to ensure that the cooling efficiency of the first tube group 322 is consistent. Similarly, the multiple second straight tubes 323.1 in the second tube group 323 are placed on the same plane, and the airflow can simultaneously cool all tube parts in the plane, so that the cooling efficiency of the second tube group 323 is consistent.

Adjacent straight tubes within the same tube group are connected by curved tubes.

Preferably, the first straight tube 322.1 constituting the first tube group 322 has a first axis M, and the second straight tube 323.1 constituting the second tube group 323 has a second axis N, with the first axis M and the second axis N arranged in a staggered manner.

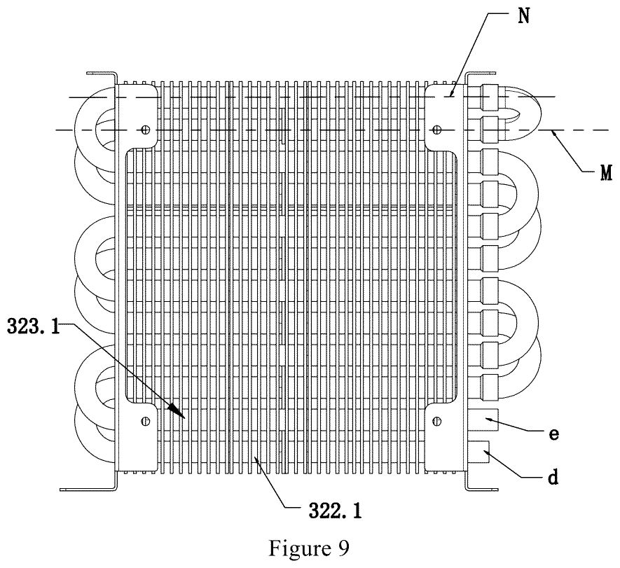

Referring specifically to FIG. 9, the first straight tube 322.1 and the second straight tube 323.1 are staggered in the output direction of the heat dissipation airflow. That is to say, the first straight tube 322.1 and the second straight tube 323.1 will not obstruct each other. When the airflow passes through the first straight tube 322.1, it passes by the side of the first straight tube 322.1, absorbs the heat from the outer surface of the first straight tube 322.1 and the surrounding air, and then flows directly toward the second straight tube 323.1, so that it can quickly approach the outer wall of the second straight tube 323.1 and absorb the heat of the second straight tube 323.1.

Preferably, the medium inlet e and the medium outlet d are located on the same side of the condenser 320 and at the same end of the fins 321 on that side.

By placing the medium inlet e and the medium outlet d on the same side of the fin 321 and at the same end of the fin 321 on that side, the medium passage within the main body can be extended as much as possible. At the same time, it facilitates the connection of the medium inlet e and the medium outlet d to the pipeline.

In this embodiment, a temperature sensor 3 is provided on the discharge seat 110, and the temperature probe 3.1 of the temperature sensor 3 extends into the processing chamber;

The temperature sensor 3 is covered with an insulation sleeve 4;

The insulation sleeve 4 is wrapped around the outer periphery of the area of the temperature sensor where the temperature sensor 3 extends to the lower part of the discharge seat 110.

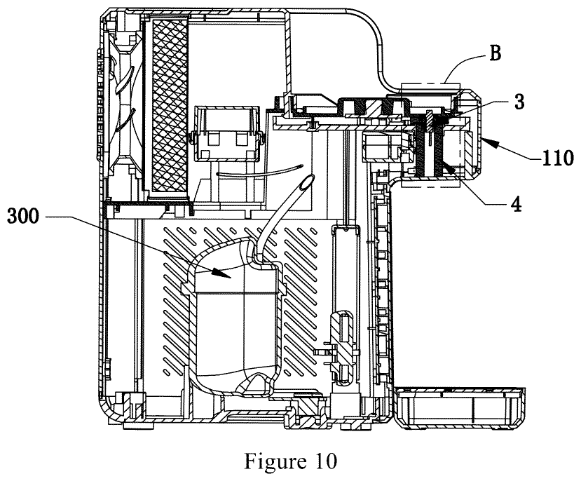

Referring to FIG. 10, the user can select the desired temperature of the smoothie beverage on the panel of the main unit 100. The circuit system inside the main unit 100 receives the feedback temperature from the temperature sensor 3 and controls the refrigeration device 300 to supply cooling, so that the outlet outputs the smoothie beverage at the corresponding temperature.

To avoid the temperature detected by the temperature sensor 3 being the real-time temperature inside the processing chamber, and to reduce the influence of the internal space of the main unit 100 on the temperature sensor 3, in this embodiment, the temperature sensor 3 is wrapped with an insulation sleeve 4 to isolate the temperature sensor 3 from the internal space of the main unit 100, thereby reducing the influence of the internal space of the main unit 100 on the temperature sensor 3.

It should be noted that the insulation function of the insulation sleeve 4 in this embodiment specifically refers to the insulation of the temperature sensor 3 when the internal temperature of the main unit 100 is lower than the internal temperature of the temperature sensor 3 itself; and the insulation of the temperature sensor 3 when the internal temperature of the main unit 100 is higher than the internal temperature of the temperature sensor 3 itself, thereby ensuring that the temperature sensor 3 located inside the insulation sleeve 4 is in a stable temperature state and is not affected by the internal temperature of the main unit 100, thus ensuring the accuracy of the temperature detected by the temperature sensor 3.

Preferably, in this embodiment, the insulation sleeve 4 is made of rubber and plastic insulation cotton.

The closed-cell foam structure of the rubber and plastic insulation cotton has an extremely low thermal conductivity (as low as 0.032-0.034 W/(m·K) at 0° C.), which can effectively isolate the sensor from the influence of external ambient temperature changes. This effectively avoids the temperature sensor 3 being affected by the internal temperature of the main unit 100, causing its own temperature to change and making it unable to accurately measure the medium temperature.

Furthermore, since different locations of the temperature sensor 3 are exposed to different temperature environments, condensation can easily form on its surface due to temperature differences, leading to measurement errors or even short-circuit failures. The rubber and plastic insulation cotton has a moisture resistance factor μ≥3500, possessing excellent resistance to water vapor penetration. It can form a “built-in waterproof vapor barrier” on the surface of the temperature sensor 3. Even if the material is locally scratched, it will not affect the overall vapor barrier performance, completely eliminating condensation problems and ensuring data stability.

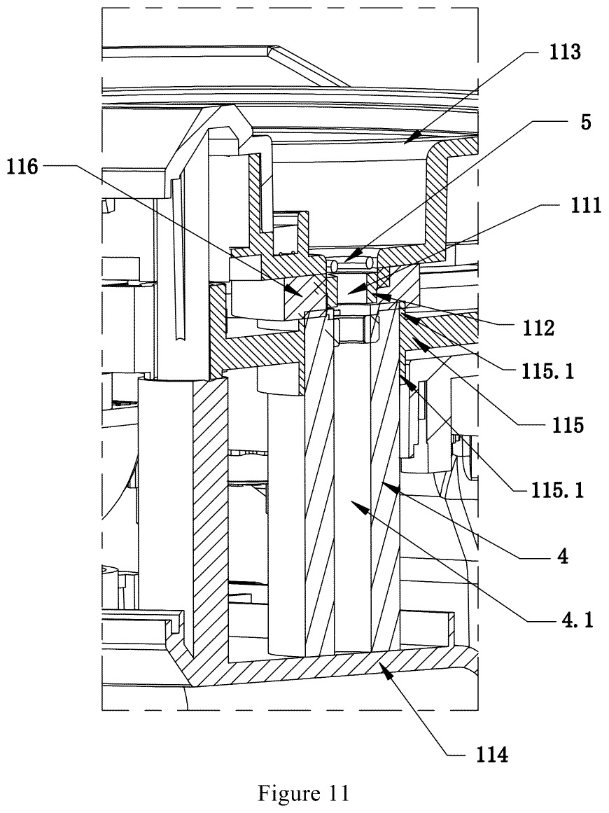

Referring specifically to FIG. 11, in this embodiment, the discharge seat 110 is formed with a through stepped hole 111, the temperature sensor 3 is limited and installed in the stepped hole 111, and the temperature probe 3.1 is exposed to the processing chamber.

The insulation sleeve 4 is wrapped around the outer periphery of the area where the temperature sensor 3 extends to the lower part of the discharge seat 110.

Since the temperature sensor 3 needs to detect the temperature of the smoothie in real time, the temperature probe 3.1 needs to be in direct contact with the smoothie. The wiring part 3.2 of the temperature sensor 3 needs to be connected to the circuit system inside the main unit 100. Since the wiring part 3.2 is located directly inside the main unit 100, in this embodiment, the temperature probe 3.1 is exposed to the processing chamber, while the wiring part 3.2 is insulated and wrapped.

Specifically, a stepped hole 111 is provided on the discharge seat 110. The upper part of the temperature sensor 3 is installed into the stepped hole 111, and the temperature probe 3.1 at the upper end of the temperature sensor 3 protrudes above the end face of the discharge seat 110, ensuring that it can contact the smoothie beverage in the processing chamber. At the same time, the lower part of the temperature sensor 3 extends into the lower part of the discharge seat 110 through the stepped hole 111 and is electrically connected to the circuit system inside the main unit 100. The insulation sleeve 4 covers the lower part of the temperature sensor 3, isolating the part located in the space of the main unit 100 from the internal environment of the main unit 100.

Preferably, in this embodiment, a sealing ring 5 is provided inside the stepped hole 111.

The sealing ring 5 forms a seal between the temperature sensor 3 and the stepped hole 111 to prevent the smoothie beverage in the processing chamber from seeping into the main unit 100 through the gap between the stepped hole 111 and the temperature sensor 3, thereby damaging the components inside the main unit 100.

Furthermore, to ensure the stability of the temperature sensor 3 on the discharge seat 110, in this embodiment, the wall of the stepped hole 111 extends downward to form a sleeve 112, and the lower end of the sleeve 112 and the upper end of the insulation sleeve 4 are fitted with a clearance.

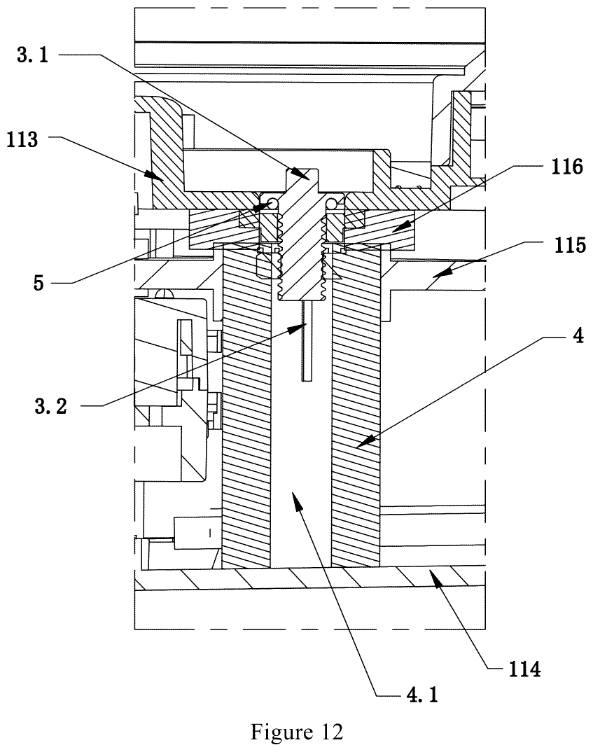

Referring specifically to FIG. 12, the discharge seat 110 is configured as a hollow shell with a control space, consisting of a discharge top 113 and a support shell 114. The discharge top 113 is a plate. When the temperature sensor 3 is installed on the discharge seat 110, it is prone to shaking. Therefore, in this embodiment, the installation part of the temperature sensor 3 is thickened, that is, the hole wall of the stepped hole 111 is extended downward, and the axial length of the stepped hole 111 is extended simultaneously, thereby increasing the installation length of the temperature sensor 3 in the stepped hole 111 and reducing the instability of the temperature sensor 3.

Furthermore, the lower end of the sleeve 112 and the insulation sleeve 4 are fitted with a gap, that is, the upper area of the temperature sensor 3 is constrained and installed inside the sleeve 112, and the lower area is constrained and installed inside the insulation sleeve 4, thereby achieving all-round constraint on the temperature sensor 3. In addition, in this embodiment, the sleeve 112 and the insulation sleeve 4 are coaxially arranged, thereby ensuring the stability of the temperature sensor 3 and enabling accurate temperature measurement of the smoothie beverage in the preparation chamber.

In this embodiment, the discharge seat 110 is configured as a hollow shell with a control space, consisting of a discharge top 113 and a support shell 114, and the power connection part of the temperature sensor 3 is located in the control space.

The insulation sleeve 4 is supported at the upper and lower ends of the control space.

Specifically, the support shell 114 is a shell formed on the main body 100 shell and arranged below the discharge top 113. It includes a bottom shell and side enclosure, and the upper end is covered and enclosed by the discharge top 113 to form a shell structure with control space.

The processing chamber is located above the discharge seat 110. A discharge channel is provided between the discharge seat 110 and the support shell 114. A valve body 1 is provided inside the support shell 114 to open and close the discharge channel. The user places the receiving container under the support shell 114 to receive the output smoothie beverage.

The insulation sleeve 4 is set in the space formed by the discharge seat 110 and the support shell 114, and is limited by the discharge seat 110 and the support shell 114 to ensure the stability of the position of the insulation sleeve 4, thereby ensuring the stability of the position of the temperature sensor 3 located inside the insulation sleeve 4, which can accurately and stably measure the temperature of the smoothie beverage.

Preferably, in this embodiment, an isolation layer 115 is further provided in the control space, and the isolation layer 115 is provided with a clearance groove that can accommodate the passage of the power receiving part;

The lower end of the isolation layer 115 is provided with limiting ribs 115.1 around the clearance groove; the upper end of the insulation sleeve 4 is constrained within the limiting groove formed by the limiting ribs 115.1.

The isolation layer 115 is located between the discharge seat 110 and the bottom shell of the support shell 114, and is arranged parallel to the discharge seat 110 and the bottom shell, separating the control space into two spaces arranged vertically. The purpose is that after the control space is isolated into two small spaces arranged vertically, the internal space of the main unit 100 is connected to the lower small space, while the upper small space forms a heat-insulating space, which can further isolate the temperature probe 3.1 from the internal space of the main unit 100.

Furthermore, the insulation sleeve 4 is located in the small space at the bottom, that is, between the isolation layer 115 and the bottom shell. A ring of limiting ribs 115.1 is formed on the lower end surface of the isolation layer 115. The limiting ribs 115.1 form a limiting groove with the same cross section as the protective sleeve. The upper end of the insulation sleeve 4 is constrained in the limiting groove.

The insulation sleeve 4 has a through hole 4.1 along the axial direction. The electrical connection part is inserted into the first end of the through hole 4.1, and the second end is used for the connection of the wire.

The electrical connection part of the temperature sensor 3 is inserted into the through hole 4.1 from the upper end of the insulation sleeve 4. The wire used to connect to the circuit system can be inserted into the through hole 4.1 from the lower end of the insulation sleeve 4, and the connection with the temperature sensor 3 is realized inside the through hole 4.1.

Preferably, in this embodiment, the insulation sleeve 4 has deformability, which can compress the wire between the insulation sleeve 4 and the bottom shell to fix the wire.

In this embodiment, a temperature-insulating space is formed between the discharge seat 110 and the isolation layer 115, and a stabilizing ring 116 is sandwiched in the temperature-insulating space. The stabilizing ring 116 is sleeved on the outside of the temperature sensor 3.

Due to the setting of the isolation layer 115, the small space formed between the isolation layer 115 and the discharge seat 110 is a heat insulation space. In order to ensure that the spacing of this space is consistent, in this embodiment, an annular support is set in the heat insulation space. The upper and lower ends of the annular support abut against the discharge seat 110 and the isolation layer 115 respectively, supporting the distance between the discharge seat 110 and the isolation layer 115, and preventing the temperature sensor 3 installed through the discharge seat 110 and the isolation layer 115 from shifting due to deformation of the discharge seat 110 or the isolation layer 115.

Preferably, in this embodiment, the stabilizing ring 116 is disposed on the outside of the sleeve 112, enclosing the sleeve 112. Furthermore, the upper end face of the insulating layer 115 extends with a limiting rib 115.1 that is consistent with the lower end face. This limiting rib 115.1 constrains the upper end of the insulation sleeve 4 and simultaneously limits the position of the stabilizing ring 116. The stabilizing ring 116 is disposed outside the limiting rib 115.1, thereby ensuring that the stabilizing ring 116, the limiting rib 115.1, and the sleeve 112 are arranged coaxially.

In this embodiment, the main unit 100 is formed with a handle 131, which is symmetrically arranged on both sides of the bottom of the main unit 100 and has a force-bearing end surface 131.1 for the fingertips to contact.

The force-bearing end face 131.1 is the upper end face of the handle 131.

Preferably, the handle 131 is formed on the bottom shell body 130 at the lower end of the main unit 100.

When a user needs to move the slush machine, they can place their hands on both sides of the bottom shell body 130 and insert their fingers into the handle 131, abutting against the force-bearing end face 131.1 of the handle 131. When the slush machine is lifted, the weight of the slush machine is applied to the fingers through the force-bearing end face 131.1, and the user can feel the weight of the slush machine and exert corresponding force to lift the slush machine.

Preferably, in this embodiment, the handle 131 is a recess formed at both ends of the bottom shell body 130, and the recess extends toward the center of the bottom shell body 130, with its length extending along the front-back direction of the slush machine.

To ensure the consistency of the appearance of the slush machine, in this embodiment, the handle 131 is set at the bottom of the slush machine. Specifically, the handle is set at both ends of the bottom shell body 130, and the depth of the handle extends toward the middle of the bottom shell body 130, while the length extends along the front and back direction of the slush machine.

The main unit 100 includes a side enclosure 140 and a bottom shell body 130. Based on this configuration, when the side enclosure 140 is installed on the bottom shell body, it conceals the handle 131; that is, the recess is located below the side enclosure 140 and cannot be observed from above or from the front or back of the slush machine. The handle 131 is hidden at the bottom of the slush machine body, thus fulfilling the requirement for a consistent appearance of the slush machine.

In this embodiment, the bottom shell body 130 has arc-shaped bottom enclosure 132 formed at both ends of the handle 131 along the length direction, and the upper end of the bottom enclosure 132 is connected to the side enclosure 140.

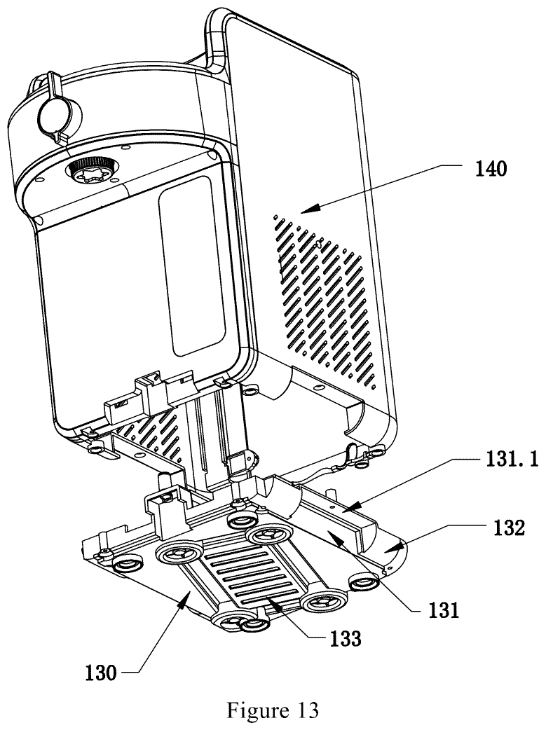

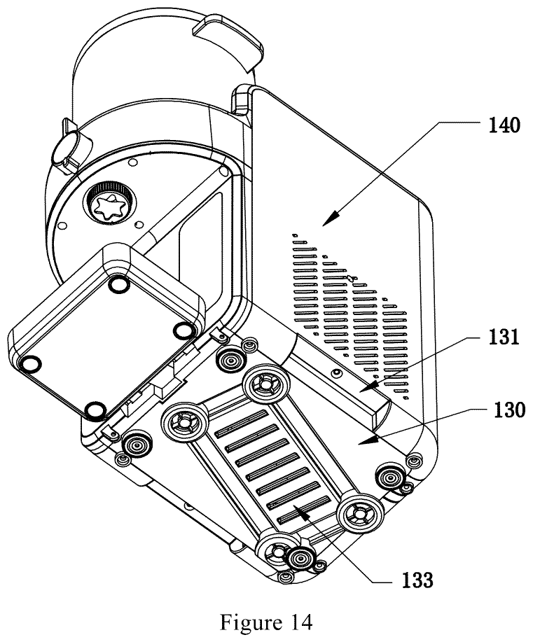

Referring specifically to FIGS. 13 and 14, the front and rear sides of the handle 131 are designed as convex arc-shaped surfaces. The upper end of the arc-shaped surface extends upward and can align with the lower end of the side enclosure 140 to form a complete shape. At the same time, in the front and rear view direction, the recessed structure of the handle 131 is hidden due to the design of the bottom enclosure 132.

In addition, in this embodiment, a cooling component is installed inside the main unit 100 of the slush machine. The cooling component generates heat during operation, causing the internal temperature of the main unit 100 to rise. To ensure the normal operation of the internal components, it is necessary to dissipate heat from inside the main unit 100 to the outside. Simultaneously, external air needs to enter the main unit 100 to ensure airflow circulation. Specifically, the bottom shell body 130 is provided with an air inlet area 133, which has multiple air inlet slots 133.1 arranged thereon, and air guide strips 133.2 are formed along the edges of the air inlet slots 133.1.

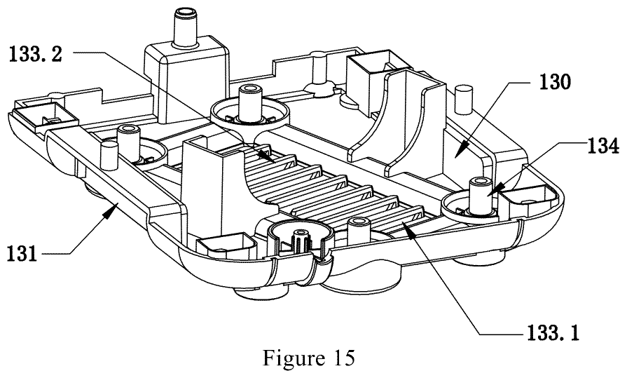

Referring specifically to FIG. 15, the air inlet area 133 is located in the middle of the bottom shell body 130, and preferably below the cooling component. The air inlet slots 133.1 are arranged throughout the air inlet area 133, and under the action of the air guide strips 133.2, the external airflow can enter the main unit 100 along the guiding direction of the air guide strips 133.2.

Furthermore, in this embodiment, the air guide strip 133.2 is formed inside the main unit 100, that is, the upper end surface of the bottom shell body 130, to guide the airflow entering the main unit 100 to the side of the air outlet grille 120.

When the airflow circulates, the cooling components inside the main unit 100 need to be cooled. Therefore, when the external airflow enters the main unit 100, it preferably passes through the cooling components. Specifically, in this embodiment, the bottom shell body 130 is provided with a mounting column 134 around the air inlet area 133. The mounting column 134 extends toward the inner cavity and is used to install the compressor 310.

Heat inside the main unit 100 is output from the air outlet of the casing by the cooling fan 330. At the same time, a negative pressure is formed inside the main unit 100. Under the action of the negative pressure, the outside air enters the main unit 100 from the air inlet slot 133.1 and first comes into contact with the compressor 310 to cool the compressor 310. Then it passes through other components in sequence to achieve maximum heat dissipation efficiency.

The above description is merely a preferred embodiment of the present disclosure and is not intended to limit the present disclosure in any way. Although the present disclosure has been disclosed above with reference to preferred embodiments, it is not intended to limit the present disclosure. Any person skilled in the art can make some modifications or alterations to the above-disclosed technical content to create equivalent embodiments without departing from the scope of the present disclosure. Any simple modifications, equivalent changes and alterations made to the above embodiments based on the technical essence of the present disclosure without departing from the scope of the present disclosure shall still fall within the scope of the present disclosure.

What is claimed is:

1. A vertical slush machine, comprising:
a main unit (100) equipped with a discharge seat (110) for dispensing smoothie beverages;
a processing component (200), vertically positioned above the discharge seat (110) and forms a connection with the discharge seat (110);
a processing chamber (a), connected to a discharge port (b) of the discharge seat (110);
a refrigeration device (300), located inside the main unit (100), used to cool the processing component (200);
wherein the processing component (200) comprises an ice-making cylinder (210), a scraper (220) sleeved on the outside of the ice-making cylinder (210), and a material cylinder (230), wherein the material cylinder (230) and the ice-making cylinder (210) constitute the processing chamber (a);
the material cylinder (230) is hollow inside and extends to a lower opening, and a lower end of the material cylinder abuts against an upper surface of the discharge seat (110) so that the processing chamber (a) and the discharge port (b) are connected;
the top of the material cylinder (230) is provided with a liquid injection part, and the top of the material cylinder (230) is openable and a material cylinder cover (240) is provided to cover the liquid injection part;
the material cylinder cover (240) is provided with a balancing air passage (241);
the material cylinder cover (240) has a groove (241.1), a groove wall of the groove (241.1) extends toward the liquid injection part and has an air groove (241.2), the groove (241.1) and the air groove (241.2) are connected to form a balancing air passage (241) connecting the liquid injection part and the outside.

2. The vertical slush machine according to claim 1, wherein the top of the material cylinder (230) is provided with a plurality of liquid injection holes (231.1), and the liquid injection holes (231.1) penetrate through the top of the material cylinder (230);
the top of the material cylinder (230) is recessed to form a liquid guiding groove (231), and the liquid injection holes (231.1) are formed at the bottom of the liquid guiding groove (231);
the liquid guiding groove (231) and the liquid injection holes (231.1) together constitute the liquid injection part.

3. The vertical slush machine according to claim 2, wherein the liquid guiding groove (231) comprises a liquid inlet area (231.2) located in the center and a liquid guiding area (231.3) surrounding the liquid inlet area (231.2), wherein an inner connecting end of the liquid guiding area (231.3) is lower than an outer connecting end of the liquid guiding area.

4. The vertical slush machine according to claim 1, wherein a central liquid hole (231.4) is provided at the center of the liquid injection part, and arc-shaped baffles (232) are formed around the central liquid hole (231.4) on the inner wall of the material cylinder (230), and multiple arc-shaped baffles (232) constitute a baffle ring with a liquid passage gap (c);
the gap of the baffle ring is located above a rotating shaft (211) of the ice-making cylinder (210).

5. The vertical slush machine according to claim 1, wherein the refrigeration device (300) comprises a compressor (310) and a condenser (320) connected in series, the compressor (310) is fixed inside the main unit (100), a cooling fan (330) is provided on a first side of the condenser (320), a filter (340) is provided on a second side of the condenser (320), and the filter (340) is connected to a medium outlet of the condenser (320) and an input port of the processing component (200) to deliver a cooling medium to the refrigeration device.

6. The vertical slush machine according to claim 5, wherein the main unit (100) is provided with an air outlet, and the filter (340), the condenser (320) and the cooling fan (330) are arranged in sequence along the direction of airflow output.

7. The vertical slush machine according to claim 6, wherein the filter (340) is configured as a strip-shaped tube structure extending along an axis L, and a filter inlet and a filter outlet are arranged at two ends along the axis L;
the axis L is set perpendicular to an output direction of heat dissipation airflow.

8. The vertical slush machine according to claim 6, wherein a circuit board box (2) is further provided inside the main unit (100) for accommodating a circuit board; the circuit board box (2) is located on one side of the filter (340) and forms a first heat dissipation plane perpendicular to the output direction of the heat dissipation airflow together with the filter (340).

9. The vertical slush machine according to claim 1, wherein a temperature sensor (3) is provided on the discharge seat (110), and a temperature probe (3.1) of the temperature sensor (3) extends into the processing chamber;
the temperature sensor (3) is covered with an insulating sleeve (4);
the insulation sleeve (4) is wrapped around an outer periphery of the temperature sensor (3) extending to a lower part of the discharge seat (110).

10. The vertical slush machine according to claim 1, wherein a handle (131) is formed on the main unit (100), the handle (131) is symmetrically arranged on both sides of the bottom of the main unit (100), and is provided with a force-bearing end face (131.1) for fingertips of a person to abut;
the force-bearing end face (131.1) is an upper end face of the handle (131).
